(19) United States
(12) Patent Application Publication
(10) Pub. No.: US 2014/0160946 A1
(43) Pub. Date: Jun. 12, 2014

(54) METHODS AND APPARATUS FOR IMPROVING CENTRALIZED D2D SCHEDULING

(71) Applicant: QUALCOMM INCORPORATED, San Diego, CA (US)

(72) Inventors: Shreeshankar R. Bodas, Piscataway, NJ (US); Saurabh Tavildar, Jersey City, NJ (US)

(73) Assignee: Qualcomm Incorporated, San Diego, CA (US)

(21) Appl. No.: 13/706,826

(22) Filed: Dec. 6, 2012

(51) Int. Cl. H04W 24/10

(52) U.S. Cl. CPC H04W 24/10
USPC 370/252

(57) ABSTRACT

A method, an apparatus, and a computer program product for wireless communication are provided in connection with minimizing D2D overhead resource usage. In one example, a first UE is equipped to measure a first received power value from a second UE with which the first UE has a D2D link, and a received power value from each UE of one or more other UEs, determine whether the received power value from any of the one or more other UEs is greater than a relevant interferer threshold, and transmit the received power value for any of the one or more other UEs for which the received power value is determined to be greater than the relevant interferer threshold. In an aspect, the relevant interferer threshold may be based on a fractional value of the first received power value.

### BACKGROUND

1. Field

The present disclosure relates generally to communication systems, and more particularly, to reduction of overhead information communicated during centralized D2D scheduling in a wireless wide area network (WWAN).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. LTE may support direct device-to-device (peer-to-peer) communication (e.g., LTE-Direct).

Currently, an aspect of supporting device to device (D2D) communications in an LTE environment (e.g., LTE-Direct) is D2D scheduling. D2D scheduling refers to the mechanism of coordinating, the D2D transmissions of different links without incurring excessive interference among them. Currently, in order for a network entity (e.g., eNB, MME, etc.) to schedule the device to device (D2D) links, the network entity has to obtain information related to interference caused across D2D links. One way of achieving this is for the UEs to measure all the wireless channel gains (e.g., pathlosses) and report them to the network entity. Under such an implementation, for N D2D links, the measurement overhead scales as O(N²). This overhead can become significant in terms of time frequency resources used.

As the demand for device-to-device communication increases, there exists a need for methods/apparatuses for supporting device-to-device communication within LTE while minimizing overhead resource usage.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with minimizing D2D overhead resource usage. In one example, a first UE is equipped to measure a first received power value from a second UE with which the first UE has a D2D link, and a received power value from each UE of one or more other UEs, determine whether the received power value from any of the one or more other UEs is greater than a relevant interferer threshold, and transmit the received power value for any of the one or more other UEs for which the received power value is determined to be greater than the relevant interferer threshold. In an aspect, the relevant interferer threshold may be based on a fractional value of the first received power value.

According to related aspects, a method for minimizing D2D overhead resource usage is provided. The method can include measuring, by a first UE, a first received power value from a second UE with which the first UE has a D2D link. Further, the method can include measuring a received power value from each UE of one or more other UEs. Further, the method can include determining whether the received power value from any of the one or more other UEs is greater than a relevant interferer threshold. In an aspect, the relevant interferer threshold may be based on a fractional value of the first received power value. Moreover, the method may include transmitting the received power value for any of the one or more other UEs for which the received power value is determined to be greater than the relevant interferer threshold.

Another aspect relates to a communications apparatus for minimizing D2D overhead resource usage. The communications apparatus can include means for measuring, by a first UE, a first received power value from a second UE with which the first UE has a D2D link. Further, the communications apparatus means for measuring may be configured to measure a received power value from each UE of one or more other UEs. Further, the communications apparatus can include means for determining whether the received power value from any of the one or more other UEs is greater than a relevant interferer threshold. In an aspect, the relevant interferer threshold may be based on a fractional value of the first received power value. Moreover, the communications apparatus can include means for transmitting the received power value for any of the one or more other UEs for which the received power value is determined to be greater than the relevant interferer threshold.

Another aspect relates to a communications apparatus. The apparatus can include a processing system configured to measure, by a first UE, a first received power value from a second UE with which the first UE has a D2D link. Further, the processing system may be configured to measuring a received power value from each UE of one or more other UEs. Further, the processing system may be configured to determine whether the received power value from any of the one or more other UEs is greater than a relevant interferer threshold. In an aspect, the relevant interferer threshold may be based on a fractional value of the first received power value. Moreover, the processing system may further be configured to transmit the received power value for any of the one or more other UEs for which the received power value is determined to be greater than the relevant interferer threshold.

Still another aspect relates to a computer program product, which can have a computer-readable medium including code for measuring, by a first UE, a first received power value from a second UE with which the first UE has a D2D link. Further, the computer-readable medium can include code for measuring a received power value from each UE of one or more other UEs. Further, the computer-readable medium can include code for determining whether the received power value from any of the one or more other UEs is greater than a relevant interferer threshold. In an aspect, the relevant interferer threshold may be based on a fractional value of the first received power value. Moreover, the computer-readable medium can include code for transmitting the received power value for any of the one or more other UEs for which the received power value is determined to be greater than the relevant interferer threshold.

According to related aspects, a method for minimizing D2D overhead resource usage is provided. The method can include transmitting D2D scheduling information to a plurality of UEs. Further, the method can include receiving, from a reporting UE of the plurality of UEs, information including a received power value for at least one other UE of the plurality of UEs. In an aspect, the received power value indicates that interference from the at least one other UE is greater than a relevant interferer threshold. Further, the method can include determining an updated D2D scheduling information based on the received information. Moreover, the method may include transmitting the updated D2D scheduling information.

Another aspect relates to a wireless communications apparatus enabled for minimizing D2D overhead resource usage. The wireless communications apparatus can include means for transmitting D2D scheduling information to a plurality of UEs. Further, the communications apparatus can include means for receiving, from a reporting UE of the plurality of UEs, information including a received power value for at least one other UE of the plurality of UEs. In an aspect, the received power value indicates that interference from the at least one other UE is greater than a relevant interferer threshold. Further, the communications apparatus can include means for determining an updated D2D scheduling information based on the received information. Moreover, the wireless communications apparatus can include means for transmitting the updated D2D scheduling information.

Another aspect relates to a wireless communications apparatus. The apparatus can include a processing system configured to transmit D2D scheduling information to a plurality of UEs. Further, the processing system may be configured to receive, from a reporting UE of the plurality of UEs, information including a received power value for at least one other UE of the plurality of UEs. In an aspect, the received power value indicates that interference from the at least one other UE is greater than a relevant interferer threshold. Further, the processing system may be configured to determine an updated D2D scheduling information based on the received information. Moreover, the processing system may further be configured to transmit the updated D2D scheduling information.

Still another aspect relates to a computer program product, which can have a computer-readable medium including code for transmitting D2D scheduling information to a plurality of UEs. Further, the computer-readable medium can include code for receiving, from a reporting UE of the plurality of UEs, information including a received power value for at least one other UE of the plurality of UEs. In an aspect, the received power value indicates that interference from the at least one other UE is greater than a relevant interferer threshold. Further, the computer-readable medium can include code for determining an updated D2D scheduling information based on the received information. Moreover, the computer-readable medium can include code for transmitting the updated D2D scheduling information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a device-to-device communications network.

FIG. 8 is a diagram illustrating communications and interference between devices in a device-to-device communications network.

FIG. 9 is a flow chart of a first method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

FIG. 12 is a flow chart of a second method of wireless communication.

FIG. 13 is a conceptual data flow diagram illustrating the data flow between different modules/means/components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

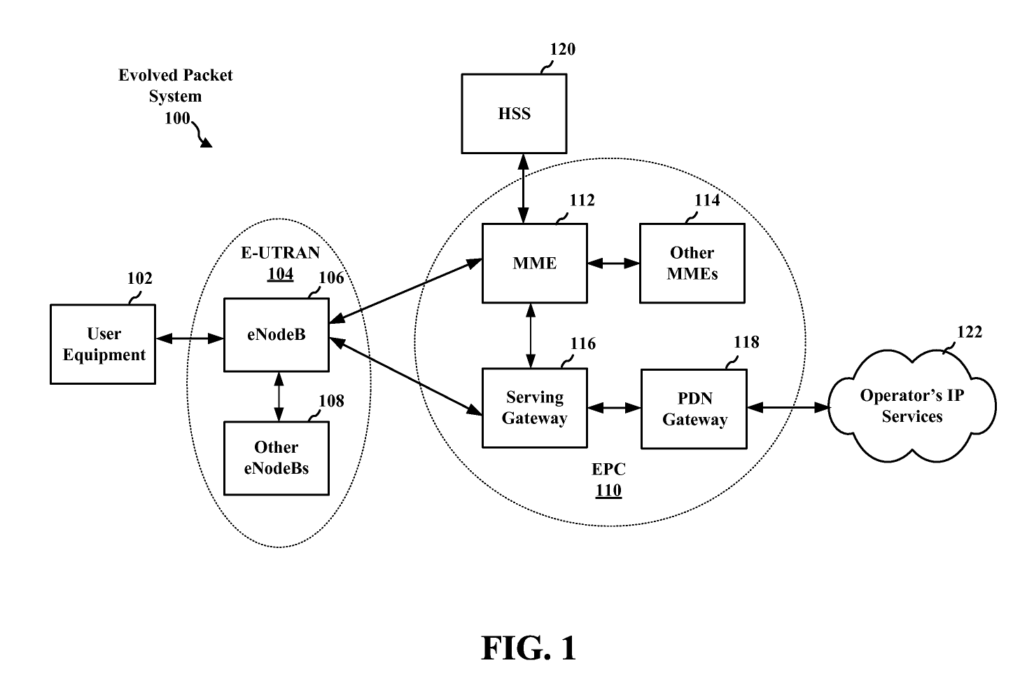

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

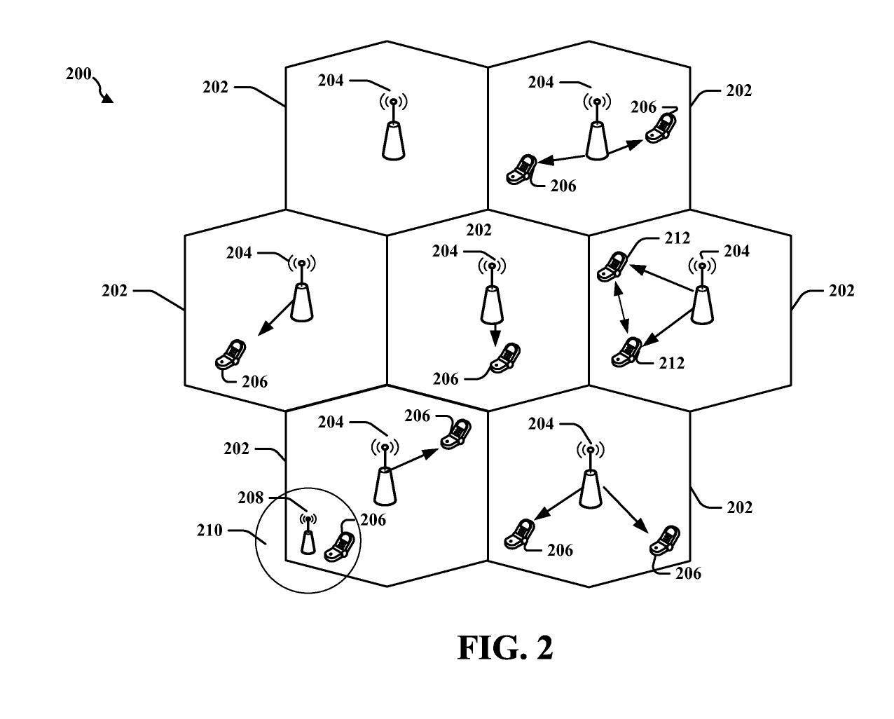

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206, 212 in the cells 202. Some of the UEs 212 may be in device-to-device communication. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

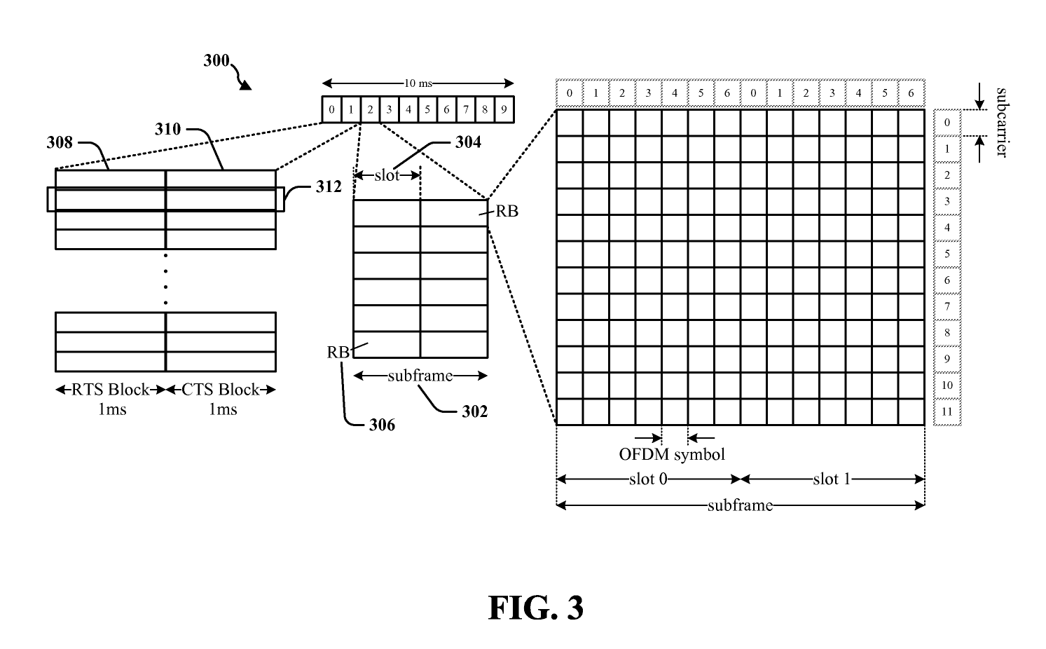

FIG. 3 is a diagram 300 illustrating an example of a DL frame structure in LTE. A frame (10 ms) may be divided into 10 equally sized sub-frames 302. Each sub-frame 302 may include two consecutive time slots 304. A resource grid may be used to represent two time slots, each time slot including a resource block (RB) 306. In LTE, the resource grid is divided into multiple resource elements. Further, in LTE, a RB 306 contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. A physical DL control channel (PDCCH), a physical DL shared channel (PDSCH), and other channels may be mapped to the resource elements.

In LTE-Direct (e.g., D2D communications in an LTE environment), scheduling of D2D communication links may be performed through distributed scheduling. In an aspect, request to send (RTS)/clear to send (CTS) handshake signaling may be performed before each device in a D2D pair attempts to communicate data over a D2D communications link. In LTE-Direct, 24 RBs may be available for RTS/CTS signaling. Further, in LTE-Direct, a RB may be assigned as a RTS block 308 and another RB may be assigned as a CTS block 310 for each D2D communication link. In other words, each D2D communication link may use a RB pair for RTS/CTS signaling. As used herein, the RB pair may be referred to as a connection identifier (CID) 312. In an operation aspect, to achieve efficient throughput of D2D communications in the LTE-Direct based network, low overhead associated with D2D scheduling may be sought. As described in further detail herein, communication of received power values from relevant interferers, rather than all received power values, may assist in reducing overhead.

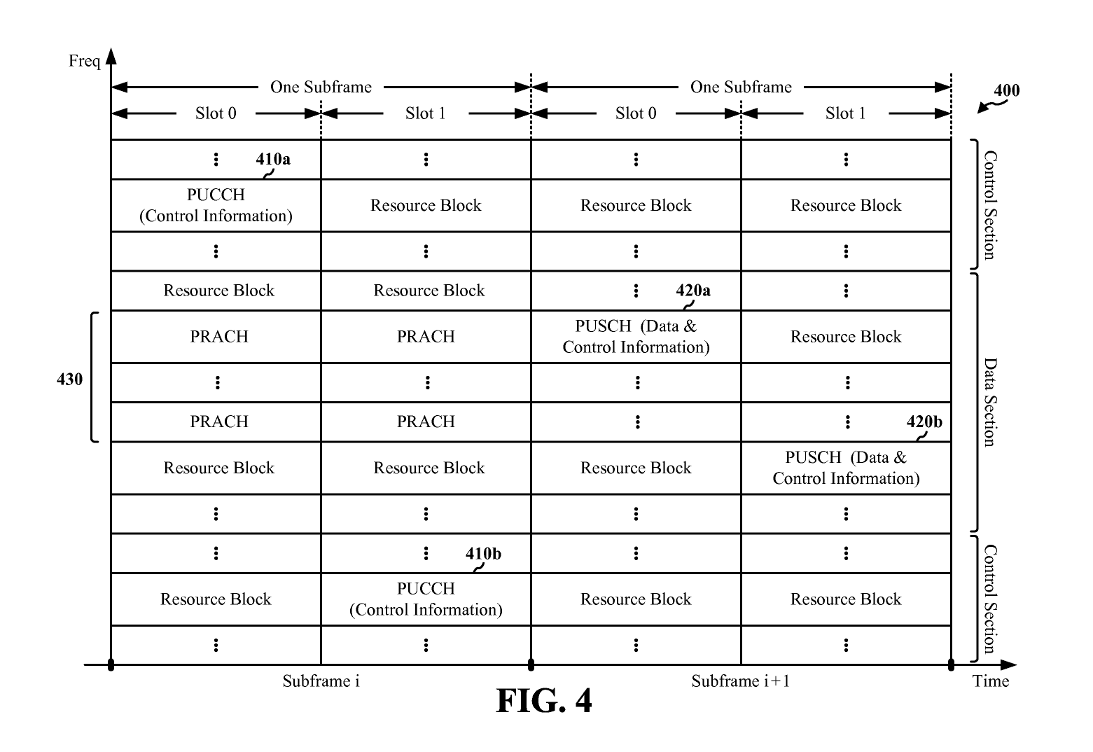

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. In an aspect, a RACH sequence may be reserved for communications of ACK/NACK information from a UE while in idle mode. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

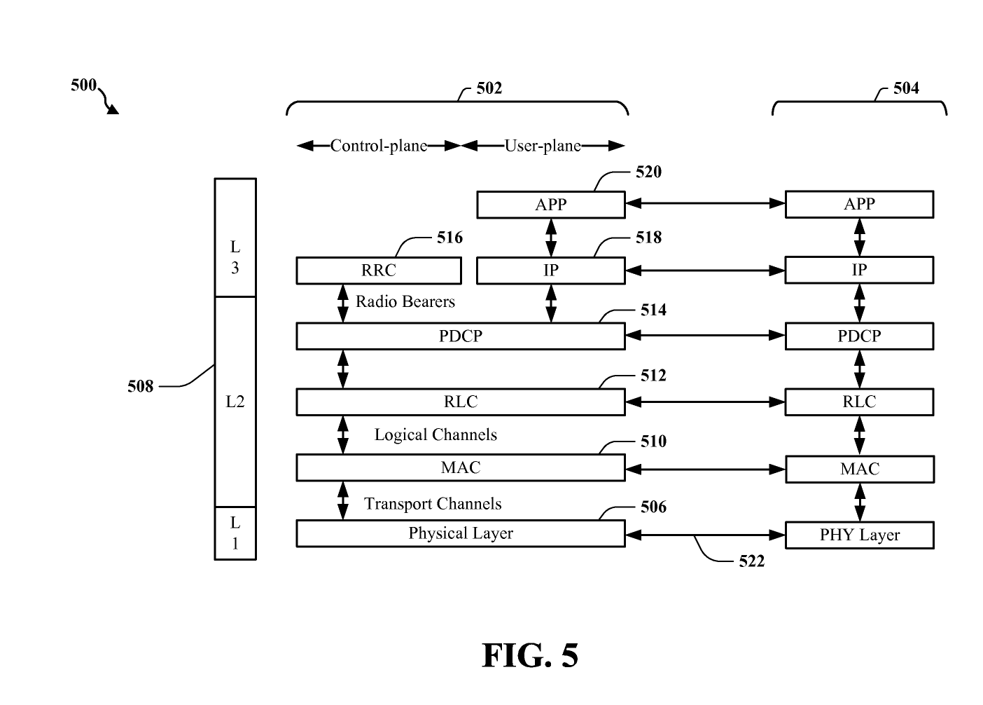

FIG. 5 is a diagram 500 illustrating an example of a radio protocol architecture for the user and control planes in LTE. The radio protocol architecture for the 502 UE and the 504 eNB is shown with three layers: Layer 1, Layer 2, and Layer 3. Communication 522 of data/signaling may occur between UE 502 and eNB 504 across the three layers. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB 504 and the UE 502. The user plane also includes an internet protocol (IP) sublayer 518 and an application sublayer 520. The IP sublayer 518 and application sublayer 520 are responsible for supporting communication of application data between the eNB 504 and the UE 502.

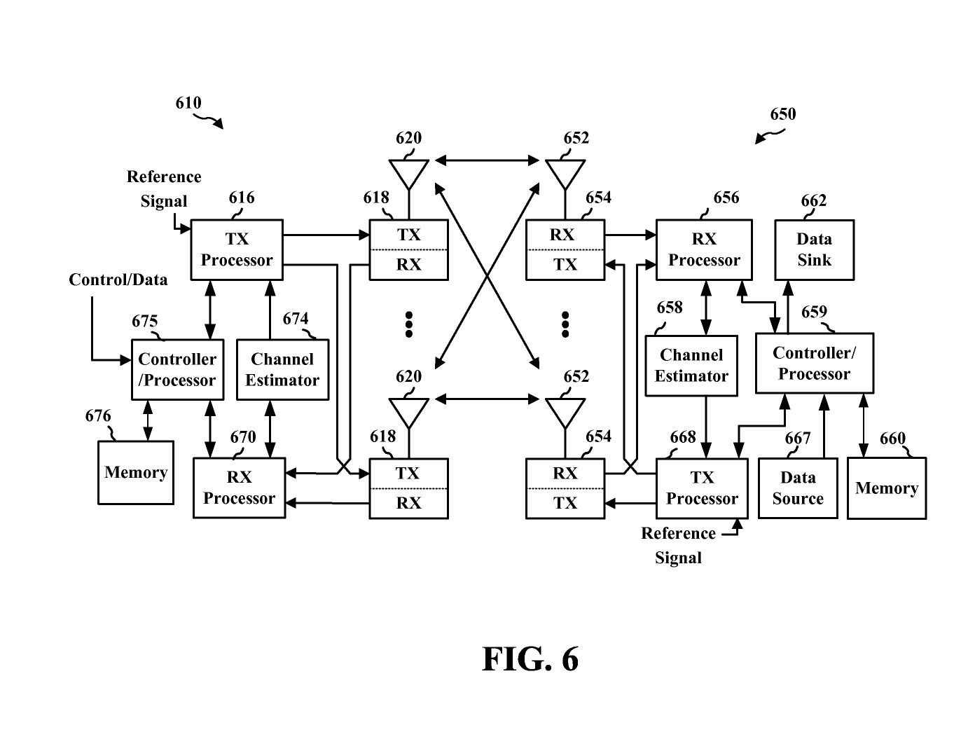

FIG. 6 is a block diagram of a WAN entity (e.g., eNB, MME, etc.) 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the WAN entity 610. These soft decisions may be based on channel estimates computed by the channel estimator 658. The soft decisions are then decoded and deinterleaved to recover the data and control signals that were originally transmitted by the WAN entity 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the WAN entity 610, the controller/processor 659 implements the L2 layer for the user plane and the control plane by providing header compression, ciphering, packet segmentation and reordering, and multiplexing between logical and transport channels based on radio resource allocations by the WAN entity 610. The controller/processor 659 is also responsible for HARQ operations, retransmission of lost packets, and signaling to the WAN entity 610.

Channel estimates derived by a channel estimator 658 from a reference signal or feedback transmitted by the WAN entity 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the WAN entity 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

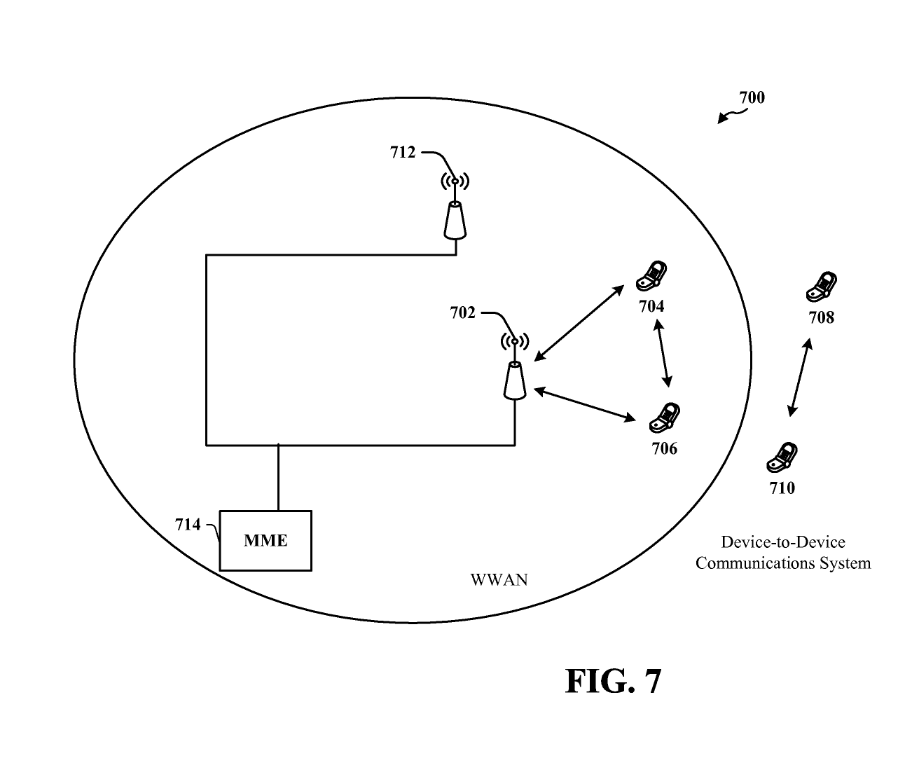

FIG. 7 is a diagram of a device-to-device communications system 700. The device-to-device communications system 700 includes a plurality of wireless devices 704, 706, 708, 710. The device-to-device communications system 700 may overlap with a cellular communications system, such as for example, a wireless wide area network (WWAN). Some of the wireless devices 704, 706, 708, 710 may communicate together in device-to-device communication using the DL/UL WWAN spectrum, some may communicate with the base station 702, and some may do both. In another aspect, the WWAN may include multiple base stations (702, 712) that may provide a coordinated communications environment through connectivity provided via one or more network entities (e.g., MME 714).

For example, as shown in FIG. 7, the wireless devices 708, 710 are in device-to-device communication and the wireless devices 704, 706 are in device-to-device communication. The wireless devices 704, 706 are also communicating with the base station 702.

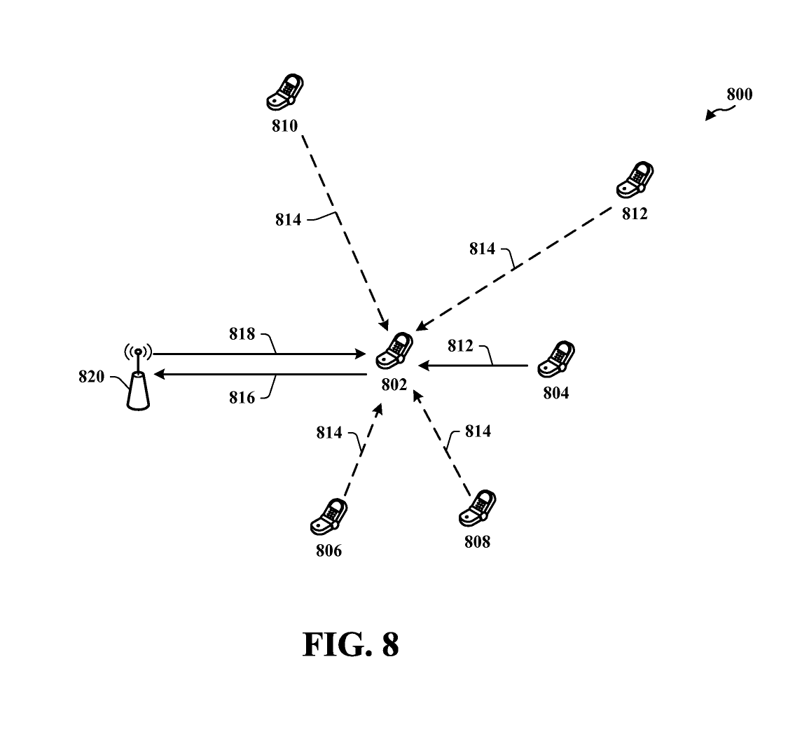

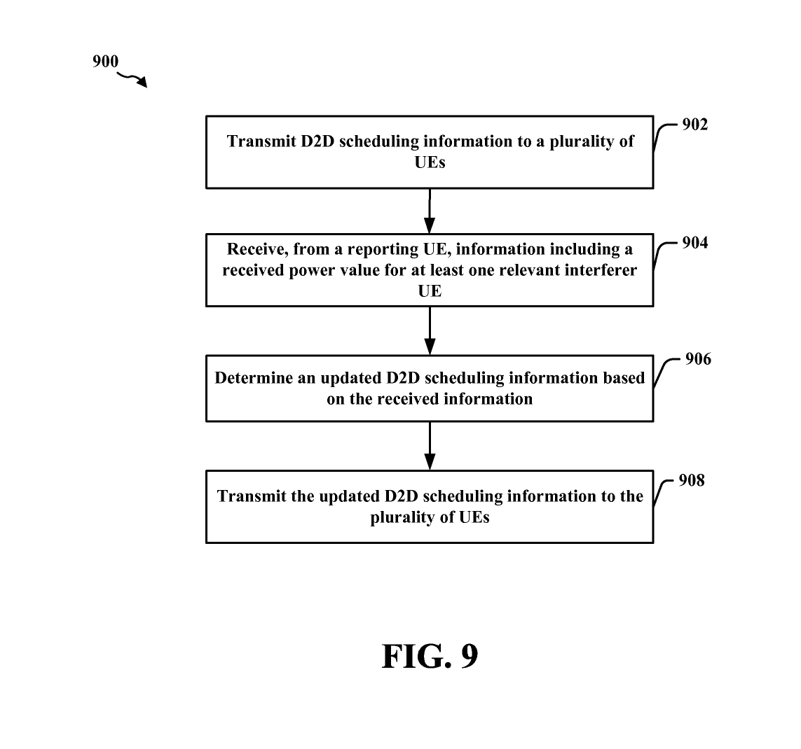

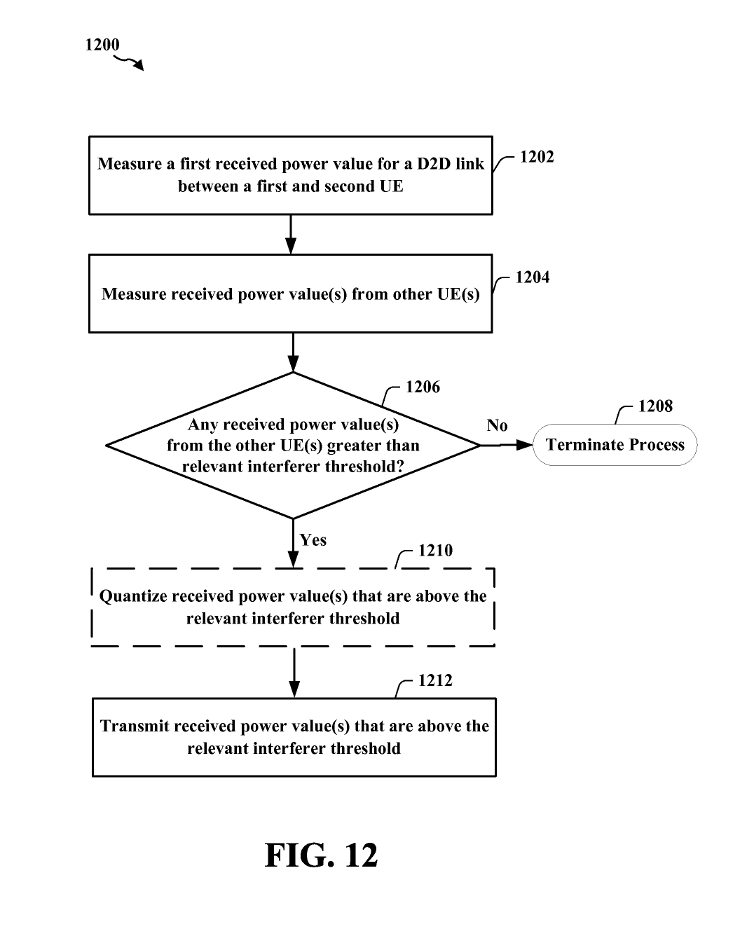

In an operational aspect, eNB 702 may communicate scheduling related information UEs (704, 706, 708, 710). In an aspect, the scheduling related information may be generated by a third party server, another UE 706, and/or an entity in the communication system 700 (e.g., MME 714, eNB 712). In an aspect, each UE may report received power values from relevant interferer UEs as opposed to all UEs. As such, a UE 702 may report a received power value associated with UE 708 while not including a measured received power from associated with UE 710. Such a determination by UE 702 allows for a reduction in overhead communications occurring in communication system 700 and/or improved efficiency in analysis of inter UE interference within the communication system 700 using current D2D scheduling information. Further discussion of a WAN entity based D2D scheduling scheme is provided with reference to FIGS. 8 and 9. Additionally, further discussion of a UE based measurements to determine relevant interferers is provided with reference to FIGS. 8 and 12.

FIG. 8 is a diagram of communications and interference between devices in a device-to-device communications network 800. Device-to-device communications network 800 may include multiple UEs (e.g., UEs 802, 804, 806, 808, 810, 812), and a WAN entity (e.g., eNB, MME, etc.) 820.

In an operational aspect, WAN entity 820 may provide UEs within the communications network 800 with D2D scheduling information 818. In an aspect, the D2D scheduling information may indicate slots and sequence numbers upon which each UE of the plurality of UE is to transmit a pilot signal, and a nominal power value at which to transmit. Based on the received D2D scheduling information 816, UE 802 may measure a received power value 812 from a UE 804 with which the UE 802 has a D2D link. Further, UE 802 may measure received power values 814 from one or more other UEs (e.g., UEs 806, 808, 810, 812). Thereafter, UE 802 may determine if any of the other UEs (e.g., UEs 806, 808, 810, 812) are relevant interferer UEs (e.g., UEs 806, 808). Such a determination may be made through comparison of each of the received power values from the other UEs with a fractional value (e.g., relevant interferer threshold) of the received power value from UE 804. In another aspect, received power values of the relevant interferer UEs may be quantized. In such an aspect, the values may be quantized around the received power value measured from UE 804. In such an aspect, the quantizing may include a plurality of levels (e.g., 64 levels) into which the received power values for the other UEs may be placed. Continuing the above operational aspect, once the UE 802 determines the relevant interferer UEs, the UE may transmit the measurement information 816 for the relevant interferer UEs to the WAN entity 820. The WAN entity 820 may analyze the received measurements 816 from UE 802 and any other reports UEs to determine whether the D2D scheduling information 818 should be updated. Upon a determination that the D2D scheduling information 818 should be updated, WAN entity 820 may transmit the updated D2D scheduling information 818.

FIGS. 9 and 12 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 9 is a flow chart 900 of a first method of wireless communication. The method may be performed by an eNodeB, an MME, etc.

At block 902, a wide area network (WAN) entity (e.g., eNB, MME, etc.) may transmit D2D scheduling information to a plurality of UEs. In an aspect, the D2D scheduling information may indicate slots and sequence numbers upon which each UE of the plurality of UE is to transmit a pilot signal, and a nominal power value at which to transmit.

At block 904, the WAN entity may receive, from a reporting UE of the plurality of UEs, information including a received power value for at least one other UE of the plurality of UEs. In an aspect, the received power value may indicate that interference from the at least one other UE is greater than a relevant interferer threshold. In an aspect, the relevant interferer threshold may be based on a fractional value of a received power value between the reporting UE and a D2D pair of the reporting UE. In another aspect, the received power value may be a quantized value. In such an aspect, the quantized value may be quantized around a received power value between the reporting UE and a D2D pair of the reporting UE.

At block 906, the WAN entity may determine an updated D2D scheduling information based on the received information.

At block 908, WAN entity may transmitting the updated D2D scheduling information. In an aspect, the updated D2D scheduling information may be broadcast to a plurality of UEs served by the apparatus 1002. In another aspect, the updated scheduling D2D information may be communicated to UEs for which scheduling information has changed.

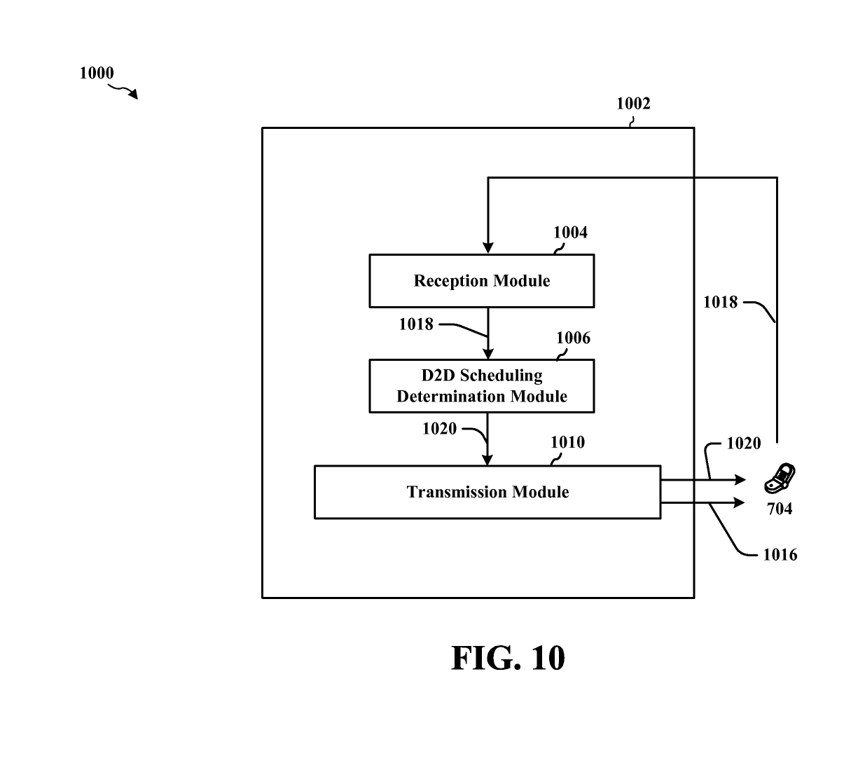

FIG. 10 is a conceptual data flow diagram 1000 illustrating the data flow between different modules/means/components in an exemplary apparatus 1002. The apparatus may be a WAN entity such as, but not limited to, an eNodeB, a MME, etc.

The apparatus 1002 includes a reception module 1004 that may receive measures 1018 from a UE (e.g., 704). In an aspect, the measurements 1018 may include one or more received power values from any UEs that the UE 704 has determined to be relevant interferer UEs. In an aspect, the UE 704 may obtain the measurements 1018 based at least in part on D2D scheduling information 1016 transmitted via transmission module 1010. Apparatus 1002 may further include D2D scheduling determination module 1006 which may generate updated D2D scheduling information 1020 based at least in part on analysis of the received measurements 1018. In an aspect, transmission module 1006 of apparatus 1002 may transmit the updated D2D scheduling information 1020. In an aspect, the updated D2D scheduling information may be broadcast to a plurality of UEs served by the apparatus 1002. In another aspect, the updated scheduling D2D information may be communicated to UEs for which scheduling information has changed.

The apparatus may include additional modules that perform each of the steps of the algorithm in the aforementioned flow charts of FIG. 9. As such, each step in the aforementioned flow charts of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

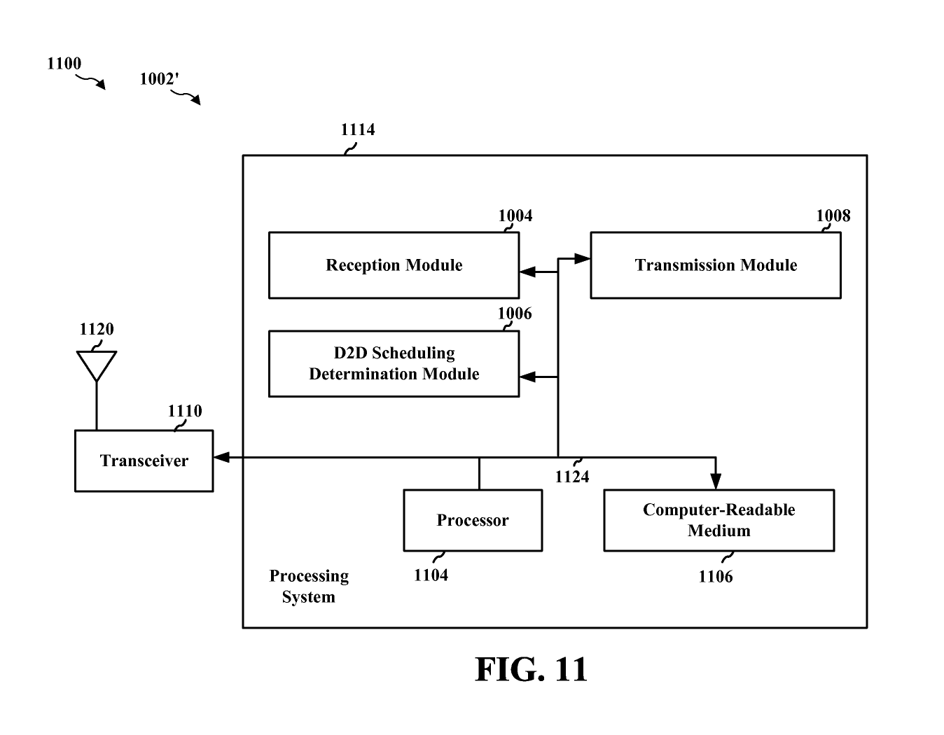

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, and 1008. The modules may be software modules running in the processor 1104, resident/stored in the computer readable medium 1106, one or more hardware modules coupled to the processor 1104, or some combination thereof. The processing system 1114 may be a component of the WAN entity 610 and may include the memory 676 and/or at least one of the TX processor 616, the RX processor 670, and the controller/processor 675.

In one configuration, the apparatus 1002/1002′ for wireless communication includes means transmitting D2D scheduling information to a plurality of UEs, means for receiving, from a reporting UE of the plurality of UEs, information including a received power value for at least one other relevant interferer UE, and means for determining an updated D2D scheduling information based on the received information. In an aspect, a relevant interfere UE may be a UE from which the first UE measured a received power value greater than a relevant interferer threshold. In an aspect, the apparatus 1002/1002′ means for transmitting may be configured to transmit the updated D2D scheduling information to the plurality of UEs.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 616, the RX Processor 670, and the controller/processor 675. As such, in one configuration, the aforementioned means may be the TX Processor 616, the RX Processor 670, and/or the controller/processor 675 configured to perform the functions recited by the aforementioned means.

FIG. 12 is a flow chart 1200 of a second method of wireless communication. The method may be performed by a UE.

At block 1202, a UE may measure a received power value (e.g., channel gain, pathloss, etc.) associated with a link with another UE (e.g., D2D link channel gain).

At block 1204, the UE may measure received power values detected from one or more other transmitting UEs. In an aspect, the UE may receive D2D scheduling information from a network entity. In such an aspect, the D2D scheduling information may include information about pilots signal transmissions by the other UEs at pre-determined slots and sequence numbers, and nominal powers. Further, the UE may measure the received power value for the UE using the D2D scheduling information.

At block 1204, the UE may determine whether any of the received powers values from the other UEs are above a relevant interferer threshold. In an aspect, the UE may report a received power value for another UE when the received power from the other UE is more than a fraction (e.g., 12/100^{th}) of the measured received power value from block 1202. For example, where there are transmitters (S, U, V, . . . ) such that the total power received by the UE from any and/or all of (S, U, V, . . . ) is no more than 12/100^{th} of that received from the D2D link UE, then the receiver UE may not report the pathlosses to the transmitters (S, U, V, . . . ).

If at block 1206, none of the other UEs have received power values above the relevant interfere threshold, then at block 1208, the UE may terminate the process without reporting any received power values.

By contrast, if at block 1206, any of the others UEs have received power values above the relevant interfere threshold, then at optional block 1210, the received power values may be quantized. In such an optional aspect, the values may be quantized around the received power value measured at block 1202. In such an aspect, the quantizing may include a plurality of levels into which the received power values for the other UEs may be placed. In an aspect, the plurality of levels may include 64 levels.

At block 1212, the received power values for the UEs above the relevant interferer threshold (optionally quantized) may be transmitted to a network entity (e.g., an eNB) to assist in facilitate centralized D2D scheduling.

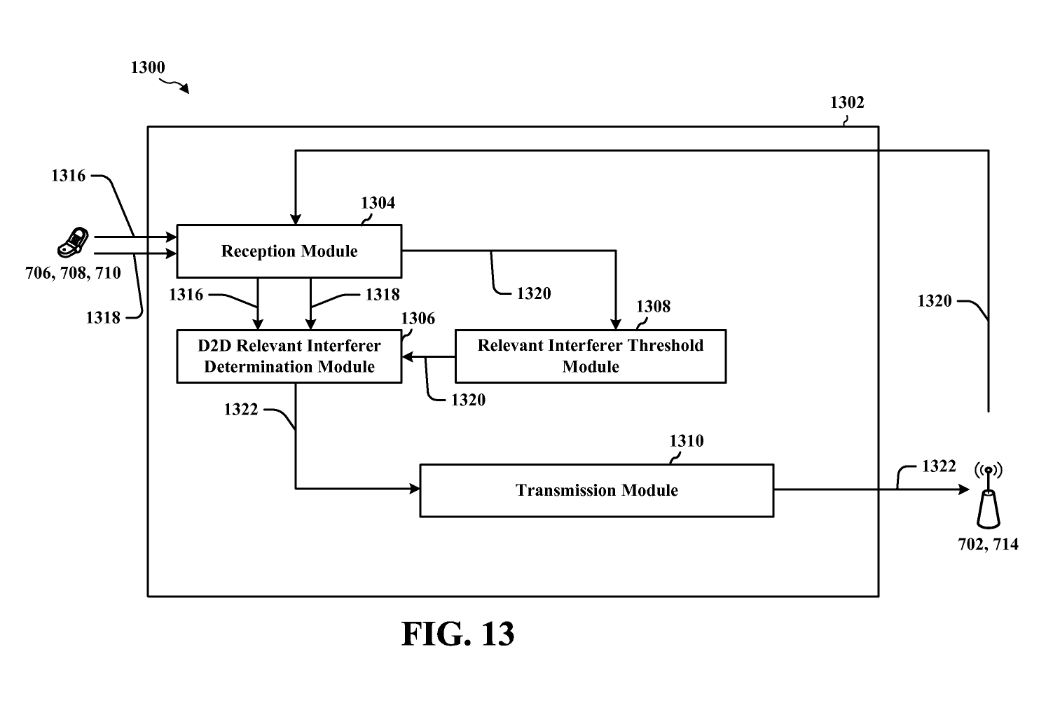

FIG. 13 is a conceptual data flow diagram 1300 illustrating the data flow between different modules/means/components in an exemplary apparatus 1302. The apparatus may be a UE.

The apparatus 1302 includes a reception module 1304 that may receives a received power value 1316 from a second UE 706 with which the first UE has a D2D link. Reception module 1304 may further received power values 1318 from each UE of one or more other UEs (e.g., 708, 710). In an aspect, reception module 1304 may further receive a relevant interferer threshold 1320 from a WAN entity (e.g., eNodeB 702, 712). In another aspect, the relevant interferer threshold 1320 may be based on a fractional value of the received power value from the second UE 706. In such an aspect, relevant interferer threshold 1320 may be communicated to relevant interferer threshold module 1308. The apparatus 1302 further includes a D2D relevant interferer determination module 1306 that may process the received power value 1316 from a second UE 706, received power values 1318 from each UE of one or more other UEs (e.g., 708, 710) along with the relevant interferer threshold 1320 to determine whether a any of the other UEs (e.g., 708, 710) are relevant interferers 1322. In another aspect, D2D relevant interferer determination module 1306 may a quantized received power value for each received power value that is determined to be greater than the relevant interferer threshold. Apparatus 1302 may further include transmission module 1310 that may transmit information at least indicating the receive power values from the UEs determined to be relevant interferers 1322.

The apparatus may include additional modules that perform each of the steps of the algorithm in the aforementioned flow charts of FIG. 12. As such, each step in the aforementioned flow charts of FIG. 12 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

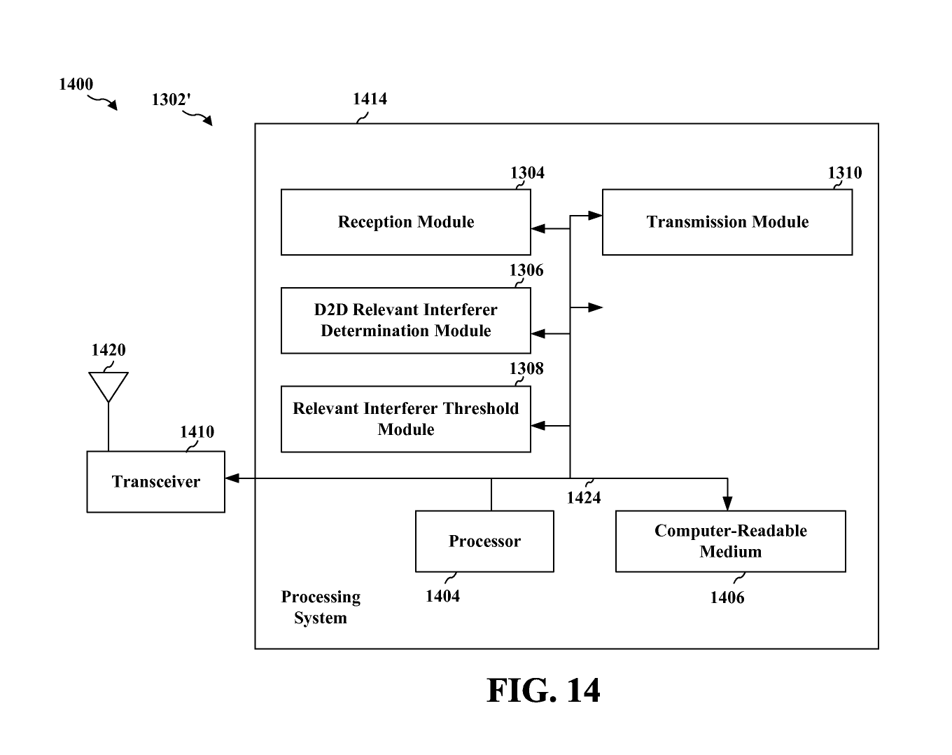

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, 1308, and 1310. The modules may be software modules running in the processor 1404, resident/stored in the computer readable medium 1406, one or more hardware modules coupled to the processor 1404, or some combination thereof. The processing system 1414 may be a component of the UE 650 and may include the memory 660 and/or at least one of the TX processor 668, the RX processor 656, and the controller/processor 659.

In one configuration, the apparatus 1302/1202′ for wireless communication includes means for measuring, by a first UE, a first received power value from a second UE with which the first UE has a D2D link, and a received power value from each UE of one or more other UEs, means for determining whether the received power value from any of the one or more other UEs is greater than a relevant interferer threshold, and means for transmitting the received power value for any of the one or more other UEs for which the received power value is determined to be greater than the relevant interferer threshold. In an aspect, the relevant interferer threshold may be based on a fractional value of the first received power value. In an aspect, the apparatus 1302/1202′ means for measuring may further be configured to receive updated scheduling information in response to the transmission. In an aspect, the apparatus 1302/1202′ means for determining may be configured to organize the multiple received power values into a structure from a weakest received power to a strongest received power, generate a running sum of the organized received power values starting from the weakest received power, and determine a point where the running sum exceeds the relevant interferer threshold. In such an aspect, the apparatus 1302/1302′ means for transmitting may be further configured to transmit the received power values for any UEs after the determined point in the organized structure. In an aspect, the apparatus 1302/1202′ means for determining may be configured to generate a quantized received power value for each received power value that is determined to be greater than the relevant interferer threshold. In such an aspect, the apparatus 1302/1302′ means for transmitting may be further configured to transmit the quantized received power value.

The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of communications, comprising:
measuring, by a first user equipment (UE), a first received power value from a second UE with which the first UE has a device-to-device (D2D) link;
measuring a received power value from each UE of one or more other UEs;
determining whether the received power value from any of the one or more other UEs is greater than a relevant interferer threshold, wherein the relevant interferer threshold is based on a fractional value of the first received power value; and
transmitting the received power value for any of the one or more other UEs for which the received power value is determined to be greater than the relevant interferer threshold.

2. The method of claim 1, wherein multiple received power values are measured by the first UE, and wherein a portion of the multiple received power values are combined for comparison with the relevant interferer threshold.

3. The method of claim 2, wherein the determining further comprises:
organizing the multiple received power values into a structure from a weakest received power to a strongest received power;
generating a running sum of the organized received power values starting from the weakest received power; and
determining a point where the running sum exceeds the relevant interferer threshold;
wherein the transmitting further comprises transmitting the received power values for any UEs after the determined point in the organized structure.

4. The method of claim 1, wherein the determining further comprises:
generating a quantized received power value for each received power value that is determined to be greater than the relevant interferer threshold, and wherein the quantized received power value is transmitted.

5. The method of claim 4, wherein the received power value is quantized around the first received power value.

6. The method of claim 4, wherein the quantized receive power is quantized into a level of a plurality of levels.

7. The method of claim 1, wherein the fractional value is 1/100th.

8. The method of claim 1, wherein the measured received power value from each UE of the one or more other UEs is based on a pilot signal.

9. The method of claim 1, further comprising receiving updated scheduling information in response to the transmission.

10. The method of claim 1, wherein the first received power value is either a pathloss value between the first and second UEs or a mean pathloss value measured by the first UE.

11. A method of communications, comprising:
transmitting device-to-device (D2D) scheduling information to a plurality of user equipments (UEs);
receiving, from a reporting UE of the plurality of UEs, information including a received power value for at least one other UE of the plurality of UEs, wherein the received power value indicates that interference from the at least one other UE is greater than a relevant interferer threshold;
determining an updated D2D scheduling information based on the received information; and
transmitting the updated D2D scheduling information.

12. The method of claim 11, wherein the relevant interferer threshold is based on a fractional value of a received power value between the reporting UE and a D2D pair of the reporting UE.

13. The method of claim 11, wherein the D2D scheduling information indicates slots and sequence numbers upon which each UE of the plurality of UE is to transmit a pilot signal, and a nominal power value at which to transmit.

14. The method of claim 11, wherein the received power value is a quantized value.

15. The method of claim 14, wherein the quantized value is quantized around a received power value between the reporting UE and a D2D pair of the reporting UE.

16. An apparatus for communication, comprising:
means for measuring, by a first user equipment (UE), a first received power value from a second UE with which the first UE has a device-to-device (D2D) link;
wherein the means for measuring are further configured to measure a received power value from each UE of one or more other UEs;
means for determining whether the received power value from any of the one or more other UEs is greater than a relevant interferer threshold, wherein the relevant interferer threshold is based on a fractional value of the first received power value; and
means for transmitting the received power value for any of the one or more other UEs for which the received power value is determined to be greater than the relevant interferer threshold.

17. The apparatus of claim 16, wherein multiple received power values are measured by the first UE, and wherein a portion of the multiple received power values are combined for comparison with the relevant interferer threshold.

18. The apparatus of claim 17, wherein the means for determining are further configured to:
organize the multiple received power values into a structure from a weakest received power to a strongest received power;
generate a running sum of the organized received power values starting from the weakest received power; and
determine a point where the running sum exceeds the relevant interferer threshold;
wherein the means for transmitting are further configured to transmit the received power values for any UEs after the determined point in the organized structure.

19. The apparatus of claim 16, wherein the means for determining is further configured to:
generate a quantized received power value for each received power value that is determined to be greater than the relevant interferer threshold, and wherein the means for transmitting is further configured to transmit the quantized received power value.

20. The apparatus of claim 19, wherein the received power value is quantized around the first received power value.

21. The apparatus of claim 19, wherein the quantized receive power is quantized into a level of a plurality of levels.

22. The apparatus of claim 16, wherein the fractional value is 1/100th.

23. The apparatus of claim 16, wherein the measured received power value from each UE of the one or more other UEs is based on a pilot signal.

24. The apparatus of claim 16 wherein the means for measuring are further configured to receive updated scheduling information in response to the transmission.

25. The apparatus of claim 16, wherein the first received power value is either a pathloss value between the first and second UEs or a mean pathloss value measured by the first UE.

26. An apparatus for communications, comprising:
means for transmitting device-to-device (D2D) scheduling information to a plurality of user equipments (UEs);
means for receiving, from a reporting UE of the plurality of UEs, information including a received power value for at least one other UE of the plurality of UEs, wherein the received power value indicates that interference from the at least one other UE is greater than a relevant interferer threshold;
means for determining an updated D2D scheduling information based on the received information; and
wherein the means for transmitting are further configured to transmit the updated D2D scheduling information.

27. The apparatus of claim 26, wherein the relevant interferer threshold is based on a fractional value of a received power value between the reporting UE and a D2D pair of the reporting UE.

28. The apparatus of claim 26, wherein the D2D scheduling information indicates slots and sequence numbers upon which each UE of the plurality of UE is to transmit a pilot signal, and a nominal power value at which to transmit.

29. The apparatus of claim 26, wherein the received power value is a quantized value.

30. The apparatus of claim 29, wherein the quantized value is quantized around a received power value between the reporting UE and a D2D pair of the reporting UE.

31. An apparatus for wireless communication, comprising:
a processing system configured to:
measure, by a first user equipment (UE), a first received power value from a second UE with which the first UE has a device-to-device (D2D) link;
measure a received power value from each UE of one or more other UEs;
determine whether the received power value from any of the one or more other UEs is greater than a relevant interferer threshold, wherein the relevant interferer threshold is based on a fractional value of the first received power value; and
transmit the received power value for any of the one or more other UEs for which the received power value is determined to be greater than the relevant interferer threshold.

32. The apparatus of claim 31, wherein multiple received power values are measured by the first UE, and wherein a portion of the multiple received power values are combined for comparison with the relevant interferer threshold.

33. The apparatus of claim 32, wherein the processing system is further configured to:
organize the multiple received power values into a structure from a weakest received power to a strongest received power;
generate a running sum of the organized received power values starting from the weakest received power; and
determine a point where the running sum exceeds the relevant interferer threshold;
transmit the received power values for any UEs after the determined point in the organized structure.

34. The apparatus of claim 31, wherein the processing system is further configured to:
generate a quantized received power value for each received power value that is determined to be greater than the relevant interferer threshold; and
transmit the quantized received power value.

35. The apparatus of claim 34, wherein the received power value is quantized around the first received power value.

36. The apparatus of claim 34, wherein the quantized receive power is quantized into a level of a plurality of levels.

37. The apparatus of claim 31, wherein the fractional value is 1/100th.

38. The apparatus of claim 31, wherein the measured received power value from each UE of the one or more other UEs is based on a pilot signal.

39. The apparatus of claim 31, wherein the processing system is further configured to receive updated scheduling information in response to the transmission.

40. The apparatus of claim 31, wherein the first received power value is either a pathloss value between the first and second UEs or a mean pathloss value measured by the first UE.

41. An apparatus for wireless communication, comprising:
a processing system configured to:
transmit device-to-device (D2D) scheduling information to a plurality of user equipments (UEs);
receive, from a reporting UE of the plurality of UEs, information including a received power value for at least one other UE of the plurality of UEs, wherein the received power value indicates that interference from the at least one other UE is greater than a relevant interferer threshold;
determine an updated D2D scheduling information based on the received information; and
transmit the updated D2D scheduling information.

42. The apparatus of claim 41, wherein the relevant interferer threshold is based on a fractional value of a received power value between the reporting UE and a D2D pair of the reporting UE.

43. The apparatus of claim 41, wherein the D2D scheduling information indicates slots and sequence numbers upon which each UE of the plurality of UE is to transmit a pilot signal, and a nominal power value at which to transmit.

44. The apparatus of claim 41, wherein the received power value is a quantized value.

45. The apparatus of claim 44, wherein the quantized value is quantized around a received power value between the reporting UE and a D2D pair of the reporting UE.

46. A computer program product, comprising:
a non-transitory computer-readable medium comprising code for:
measuring, by a first user equipment (UE), a first received power value from a second UE with which the first UE has a device-to-device (D2D) link;
measuring a received power value from each UE of one or more other UEs;
determining whether the received power value from any of the one or more other UEs is greater than a relevant interferer threshold, wherein the relevant interferer threshold is based on a fractional value of the first received power value; and
transmitting the received power value for any of the one or more other UEs for which the received power value is determined to be greater than the relevant interferer threshold.

47. The computer program product of claim 46, wherein multiple received power values are measured by the first UE, and wherein a portion of the multiple received power values are combined for comparison with the relevant interferer threshold.

48. The computer program product of claim 47, further comprising code for:
organizing the multiple received power values into a structure from a weakest received power to a strongest received power;
generating a running sum of the organized received power values starting from the weakest received power;
determining a point where the running sum exceeds the relevant interferer threshold; and
transmitting the received power values for any UEs after the determined point in the organized structure.

49. The computer program product of claim 46, further comprising code for:
generating a quantized received power value for each received power value that is determined to be greater than the relevant interferer threshold; and
transmitting the quantized received power value.

50. The computer program product of claim 49, wherein the received power value is quantized around the first received power value.

51. The computer program product of claim 49, wherein the quantized receive power is quantized into a level of a plurality of levels.

52. The computer program product of claim 46, wherein the fractional value is 1/100th.

53. The computer program product of claim 46, wherein the measured received power value from each UE of the one or more other UEs is based on a pilot signal.

54. The computer program product of claim 46, further comprising code for receiving updated scheduling information in response to the transmission.

55. The computer program product of claim 46, wherein the first received power value is either a pathloss value between the first and second UEs or a mean pathloss value measured by the first UE.

56. A computer program product, comprising:
a non-transitory computer-readable medium comprising code for:
transmitting device-to-device (D2D) scheduling information to a plurality of user equipments (UEs);
receiving, from a reporting UE of the plurality of UEs, information including a received power value for at least one other UE of the plurality of UEs, wherein the received power value indicates that interference from the at least one other UE is greater than a relevant interferer threshold;
determining an updated D2D scheduling information based on the received information; and
transmitting the updated D2D scheduling information.

57. The computer program product of claim 56, wherein the relevant interferer threshold is based on a fractional value of a received power value between the reporting UE and a D2D pair of the reporting UE.

58. The computer program product of claim 56, wherein the D2D scheduling information indicates slots and sequence numbers upon which each UE of the plurality of UE is to transmit a pilot signal, and a nominal power value at which to transmit.

59. The computer program product of claim 56, wherein the received power value is a quantized value.

60. The computer program product of claim 59, wherein the quantized value is quantized around a received power value between the reporting UE and a D2D pair of the reporting UE.
